(19) United States
(12) Patent Application Publication
(10) Pub. No.: US 2008/0237554 A1
(43) Pub. Date: Oct. 2, 2008

(54) Colored photosensitive resin composition, and color filter array and solid-state image pickup device using the same

(75) Inventors: Yoshiko Miya, Kyoto-shi (JP); Kensaku Maeda, Tokyo (JP); Taichi Natori, Tokyo (JP)

Correspondence Address: WENDEROTH, LIND & PONACK, L.L.P., 2033 K STREET N. W., SUITE 800, WASHINGTON, DC, 20006-1021, US

(73) Assignees: SUMITOMO CHEMICAL COMPANY LIMITED; SONY CORPORATION

(21) Appl. No.: 12/078,282

(22) Filed: Mar. 28, 2008

(30) Foreign Application Priority Data
Mar. 28, 2007 (JP) 2007-085895

(51) Int. Cl. G02B 5/23

(52) U.S. Cl. 252/586

(57) ABSTRACT

A colored photosensitive resin composition comprises a compound represented by the formula (I) or a salt thereof:

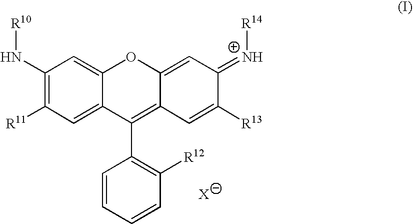

wherein R¹⁰, R¹¹, R¹³ and R¹⁴ represent independently of each other a hydrogen atom or an alkyl group;

R¹² represents a sulfonic acid group, a carboxylic acid group, an ester thereof, or an amide represented by the formula (1)

—SO₂NHR¹⁵ , and (1)

X⁻ represents BF₄⁻, PF₆⁻, Y⁻ or YO₄⁻ (in which Y represents a halogen atom), or a dye having a sulfonic acid group.

### BACKGROUND OF THE INVENTION

1. Field of the Invention

The present invention relates to a colored photosensitive resin composition which is useful to produce a color filter array to be formed on a device for coloration of a solid image pickup device (e.g., an image sensor, etc.) and a liquid crystal display.

2. Description of the Related Art

As a color filter array for coloring a solid image pickup device and a liquid crystal display, for example, there is known a color filter array in which a red filter layer (R), a green filter layer (G) and a blue filter layer (B) are formed adjacently to each other on the same plane of the device. A plane pattern of each filter layer (R, G, B) of the color filter array is appropriately set. As the filter layer, besides the combination of primary colors of red (R), green (G) and blue (B), a combination of complementary colors of yellow (Y), magenta (M) and cyan (C) may be employed.

The color filter array is usually produced by a color resist method in which colored photosensitive resin compositions corresponding to the respective filter layers are prepared and then patterned by successively exposing and developing the colored photosensitive resin compositions. Pigments are widely used as colorants contained in the colored photosensitive resin compositions. However, the pigments are not dissolved in a developing solution and they are therefore disadvantageous for forming fine patterns. Thus, the use of a dye is proposed as a colorant soluble in the developing solution (see, for example, JP-A-6-75375 (see paragraphs [0025] and [0026]); JP-B-7-111485 (see columns 12, 13 and 14); and JP-A-2002-14220 (see claims, Prior Art section, Problems to be Solved by the Invention section, paragraph [0020])).

However, good spectral characteristics and good light resistance are required of the color filter array, and color filter arrays described in JP-A-6-75375 and JP-B-7-111485 could not achieve the both characteristics at the same time. For example, in the colored photosensitive resin composition described in JP-B-7-111485, a transmittance at a wavelength of 650 nm is about 85% and that at a wavelength of 535 nm is about 0.6%, but when the transmittance at a wavelength of 650 nm is controlled to 90% or more, the transmittance at a wavelength of 535 nm tends to exceed 1% and therefore the spectral characteristics become insufficient.

Thus, JP-A-2002-14220 proposes that a specific xanthene colorant having an arylamino group bonded thereto is used in combination with a pyrazoloneazo colorant. When these colorants (or dyes) are used in a proper ratio, it is possible to control the transmittance at a wavelength of 535 nm to 1% or less and also to control the transmittance at a wavelength of 650 nm to 90% or more.

In response to the recent trends of miniaturization of a pattern of a solid image pickup device, the miniaturization of the filter pattern becomes necessary. It is effective for miniaturization of the filter pattern to improve the spectral characteristics of a color filter array and thus decrease the thickness of the color filter array itself.

### SUMMARY OF THE INVENTION

An object of the present invention is to further improve the spectral characteristics of a colored photosensitive resin composition and a color filter array.

The present inventors have intensively studied so as to achieve the above object and found that a specific xanthene colorant having an amino group or an alkylamino group bonded thereto has superior spectral characteristics to the xanthene colorant having an arylamino group bonded thereto described in JP-A-2002-14220, and thus the present invention has been completed.

Accordingly, the present invention provides a colored photosensitive resin composition comprising a photosensitive compound, an alkali-soluble resin and at least one compound selected from a compound represented by the formula (I) and a salt thereof (hereinafter collectively referred to as an “(alkyl)aminoxanthene colorant”):

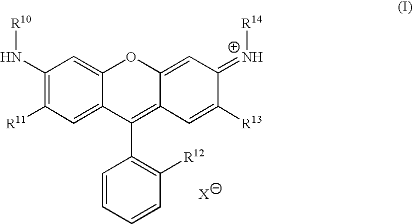

wherein

R¹⁰, R¹¹, R¹³ and R¹⁴ represent independently of each other a hydrogen atom or a C₁₋₈ alkyl group;

R¹² represents a sulfonic acid group, a carboxylic acid group, an ester thereof, or an amide represented by the formula (1)

—SO₂NHR¹⁵ (1)

in which R¹⁵ represents a C₂₋₂₀ alkyl group; a C₂₋₁₂ alkyl group substituted with a cyclohexyl group; a cyclohexyl group substituted with a C₁₋₄ alkyl group; a C₂₋₁₂ alkyl group substituted with a C₂₋₁₂ alkoxyl group; an alkylcarbonyloxyalkyl group represented by the formula (1-1); an alkoxycarbonyl alkyl group represented by the formula (1-2); a phenyl group which may be substituted with a C₁₋₂₀ alkyl group; or a C₁₋₂₀ alkyl group which may be substituted with a phenyl group:

—R¹⁷O—CO—R¹⁶ (1-1)

—R¹⁹—CO—OR¹⁸ (1-2)

in which formulae (1-1) and (1-2), R¹⁶ and R¹⁸ represent independently of each other a C₂₋₁₂ alkyl group, and R¹⁷ and R¹⁹ represent independently of each other a C₂₋₁₂ alkylene group; and

X⁻ represents BF₄⁻, PF₆⁻, Y⁻ or YO₄⁻ (in which Y represents a halogen atom), or a dye having a sulfonic acid group.

The colored photosensitive resin composition of the present invention may optionally contain a colorant having a maximum absorption in a wavelength range of 400 to 500 nm, and a curing agent. For example, the amount of such a colorant is from about 5 to 80 parts by weight, the amount of the photosensitive compound is from about 0.001 to 50 parts by weight, and the amount of the alkali-soluble resin is from about 1 to 75 parts by weight, when the total amount of the colorant, the photosensitive compound and the alkali-soluble resin is 100 parts by weight.

The colored photosensitive resin composition of the present invention is preferably used to produce a color filter array, a solid image pickup device, etc.

As used herein, “C_{a-b}” means that the number of carbon atoms is from the number “a” to the number “b”.

According to the present invention, the spectral characteristics of the color filter array formed by using the photosensitive resin composition of the present invention can further be improved, since the specific xanthene colorant having an amino group or an alkylamino group bonded thereto is used.

### BRIEF DESCRIPTION OF THE DRAWINGS

FIG. 1 is a partially enlarged schematic sectional view showing one example of a CCD image sensor.

FIGS. 2 to 7 are the first to sixth views showing a method for producing the image sensor of FIG. 1, respectively.

FIG. 8 is a block diagram showing one example of a camera system.

FIG. 9 is a graph showing wavelength-absorbance spectra of the filters of Examples and Comparative Examples.

FIG. 10 is a graph showing wavelength-transmittance spectra of the filters of Examples and Comparative Examples.

### DETAILED DESCRIPTION OF THE INVENTION

The (alkyl)aminoxanthene colorant used in the photosensitive resin composition of the present invention is represented by the formula (I). The compound of the formula (I) can further enhance the absorbance with causing substantially no change in the color tone (i.e., the maximum absorption wavelength (λₘₐₓ)) of a color filter array as compared with the arylaminoxanthene colorant described in JP-A-2002-14220, and also it can further improve the spectral characteristics of a color filter array formed by using the colored photosensitive resin composition. For example, the arylaminoxanthene colorant described in JP-A-2002-14220 can control a transmittance at a wavelength of 535 nm to 1% or less and also can control a transmittance at a wavelength of 650 nm to 90% or more only when it is used in combination with a pyrazoloneazo colorant. In contrast, the (alkyl)aminoxanthene colorant of the present invention has the function of controlling a transmittance at a wavelength of 535 nm to 1% or less and also controlling a transmittance at a wavelength of 650 nm to 90% or more even when it is used alone. Therefore, excellent spectral characteristics can be easily achieved when it is used in combination with various other colorants or dyes.

In the formula (I), R¹⁰, R¹¹, R¹³ and R¹⁴ represent independently of each other a hydrogen atom or a C₁₋₈ alkyl group. Examples of the C₁₋₈ alkyl group include a methyl group, an ethyl group, a propyl group, a butyl group, a pentyl group and a hexyl group. R¹⁰, R¹¹, R¹³ and R¹⁴ are preferably C₁₋₅ alkyl groups, more preferably a C₁₋₃ alkyl group.

R¹² represents a sulfonic acid group, a carboxylic acid group, or an ester thereof (e.g., an alkanesulfonyl group, an alkoxycarbonyl group, etc.). Examples of the alkanesulfonyl group include C₁₋₈ alkanesulfonyl groups, preferably a C₁₋₅ alkanesulfonyl group, more preferably a C₁₋₃ alkanesulfonyl group, such as a methanesulfonyl group (a mesyl group). The alkoxycarbonyl group includes carbonyl groups to which a C₁₋₈ alkoxyl group, preferably a C₁₋₅ alkoxyl group, more preferably a C₁₋₃ alkoxyl group, is bonded, for example, a methoxycarbonyl group, an ethoxycarbonyl group and a propoxycarbonyl group.

R¹² may be an amide represented by the formula (1):

—SO₂NHR¹⁵ (1)

In the formula (1), R¹⁵ represents a C₂₋₂₀ alkyl group; a C₂₋₁₂ alkyl group substituted (bonded) with a cyclohexyl group; a cyclohexyl group substituted (bonded) with a C₁₋₄ alkyl group; a C₂₋₁₂ alkyl group substituted (bonded) with a C₂₋₁₂ alkoxyl group; a phenyl group which may be substituted (bonded) with a C₁₋₂₀ alkyl group; or a C₁₋₂₀ alkyl group which may be substituted (bonded) with a phenyl group.

Examples of the C₂₋₂₀ alkyl group represented by R¹⁵ include an ethyl group, a propyl group, an n-hexyl group, an n-nonyl group, an n-decyl group, an n-dodecyl group, a 2-ethylhexyl group, a 1,3-dimethylbutyl group, a 1-methylbutyl group, a 1,5-dimethylhexyl group and a 1,1,3,3-tetramethylbutyl group. Examples of the C₂₋₁₂ alkyl group substituted with a cyclohexyl group include a cyclohexylethyl group, a 3-cyclohexylpropyl group and an 8-cyclohexyloctyl group. Examples of the cyclohexyl group substituted with a C₁₋₄ alkyl group include a 2-ethylcyclohexyl group, a 2-propylcyclohexyl group and a 2-(n-butyl)cyclohexyl group. Examples of the C₂₋₁₂ alkyl group substituted with a C₂₋₁₂ alkoxyl group include a 3-ethoxy-n-propyl group, a propoxypropyl group, a 4-propoxy-n-butyl group, a 3-methyl-n-hexyloxyethyl group and a 3-(2-ethylhexyloxy)propyl group.

Examples of the phenyl group which may be substituted with a C₁₋₂₀ alkyl group include an o-isopropylphenyl group, and examples of the C₁₋₂₀ alkyl group which may be substituted with a phenyl group include a DL-1-phenylethyl group, a benzyl group and a 3-phenyl-n-butyl group.

Furthermore, R⁵ may be an alkylcarbonyloxyalkyl group represented by the formula (1-1) described above, or an alkoxycarbonyl alkyl group represented by the formula (1-2) described above.

In the formulae (1-1) and (1-2), examples of the C₂₋₁₂ alkyl group for R¹⁶ and R¹⁸ include an ethyl group, a propyl group, an n-hexyl group, an n-nonyl group, an n-decyl group, an n-dodecyl group, a 2-ethylhexyl group, a 1,3-dimethylbutyl group, a 1-methylbutyl group, a 1,5-dimethylhexyl group, or a 1,1,3,3-tetramethylbutyl group, and examples of the C₂₋₁₂ alkylene group for R¹⁷ and R¹⁹ include a dimethylene group and a hexamethylene group.

R¹² is preferably an alkanesulfonyl group or an alkoxycarbonyl group, and particularly preferably an alkoxycarbonyl group.

X⁻ is BF₄⁻, PF₆⁻, Y⁻ or YO₄⁻ (in which formulae, Y represents a halogen atom, particularly a chlorine atom), or a dye having a sulfonic acid group.

Examples of the dye having a sulfonic acid group include C.I. Acid Yellow 17, C.I. Acid Yellow 23, C.I. Acid Yellow 25, C.I. Acid Yellow 29, C.I. Acid Yellow 38, C.I. Acid Yellow 40, C.I. Acid Yellow 42, C.I. Acid Yellow 76 and C.I. Reactive Yellow 2.

The (alkyl)aminoxanthene colorant may be a compound of the formula (I) or a salt thereof. Examples of such a salt include alkali metal salts such as a sodium salt and a potassium salt, and amine salts such as a triethylamine salt and a salt with 1-amino-3-phenylbutane. For example, when the substituent R¹² is a sulfonic acid group or a carboxylic acid group in the compound represented by the formula (I), the salt is formed by the sulfonic acid group or carboxylic acid group.

Two or more compounds of the formula (I) and/or salts thereof may be appropriately used in combination.

In a preferable (alkyl)aminoxanthene colorant, R¹⁰, R¹¹, R¹³ and R¹⁴ represent independently of each other a C₁₋₅ alkyl group (particularly a C₁₋₃ alkyl group), and R¹² is a C₁₋₅ alkoxy (particularly C₁₋₃ alkoxy) carbonyl group. A preferable example of the (alkyl)aminoxanthene colorant is C.I. Basic Red 1.

The (alkyl)aminoxanthene colorant used in the colored photosensitive resin composition of the present invention is excellent in spectral characteristics and also has the function of controlling a transmittance at a wavelength of 535 nm to 1% or less and also controlling a transmittance at a wavelength of 650 nm to 90% or more even when used alone. Accordingly, a colorant, particularly a dye, having an absorption maximum in a wavelength range of 400 to 550 nm may be used in combination so as to achieve extremely excellent spectral characteristics by properly making use of the spectral characteristics of the (alkyl)aminoxanthene colorant according to the present invention.

Examples of the colorant (or dye) having an absorption maximum in a wavelength range of 400 to 550 nm include a pyrazoloneao colorant. Various conventional pyrazoloneazo colorants may be used and, more specifically, a compound of the formula (II) or a salt thereof (e.g., an alkali metal salt, an amine salt, etc.) or a complex thereof (e.g., a chromium complex, etc.) may be used.

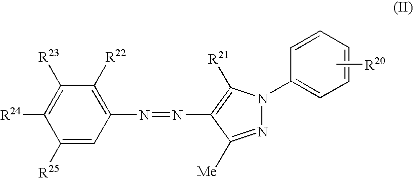

wherein R²¹ and R²² represent independently of each other a hydroxyl group or a carboxylic acid group; and R²⁰, R²³, R²⁴ and R²⁵ represent independently of each other a hydrogen atom, a halogen atom, a C₁₋₄ alkyl group, a C₁₋₄ alkoxyl group, a sulfonic acid group or a nitro group.

Specific examples of the pyrazoloneazo colorant include C.I. Acid Yellow 17, C.I. Solvent Orange 56 and C.I. Solvent Yellow 82.

The amount of the pyrazoloneazo colorant is, for example, from about 0.1 to 70 parts by weight, preferably from about 40 to 60 parts by weight, based on 100 parts by weight of the total amount of the pyrazoloneazo colorant and the (alkyl)aminoxanthene colorant, or based on 100 parts by weight of the total amount of the pyrazoloneazo colorant, the (alkyl)aminoxanthene colorant and a sulfonic acid-based arylaminoxanthene colorant, when the sulfonic acid-based arylaminoxanthene colorant is also used as described below.

In practice, the (alkyl)aminoxanthene colorant of the present invention is often used in combination with other colorant, particularly a dye, to adjust the color, for example, to control transmittance at a wavelength of 450 nm to 5% or less. Preferable examples of other colorant include a colorant, particularly a dye, having a maximum absorption in a blue wavelength range (from about 400 to 500 nm). The (alkyl)aminoxanthene colorant of the present invention transmits not only light in a red wavelength range (from about 600 to 700 nm), but also a light in a blue wavelength range (from about 400 to 500 nm). When a colorant, particularly a dye, having a maximum absorption in a blue wavelength range (from about 400 to 500 nm) is used, the color can be efficiently adjusted. Examples of the colorant having a maximum absorption in a wavelength range from about 400 to 500 nm include a pyridoneazo colorant, for example, a compound of the formula (III):

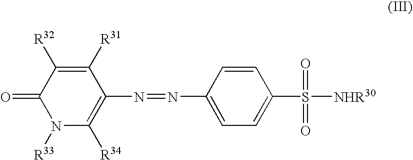

wherein R³⁰ represents a C₂₋₁₀ alkyl group (e.g., an ethyl group, a propyl group, an n-hexyl group, an n-nonyl group, an n-decyl group, an n-dodecyl group, a 2-ethylhexyl group, a 1,3-dimethylbutyl group, a 1-methylbutyl group, a 1,5-dimethylhexyl group, or a 1,1,3,3-tetramethylbutyl group, etc.); R³¹, R³² and R³⁴ represent independently of each other a hydrogen atom, a methyl group, a hydroxyl group or a cyano group; and R³³ represents a C₁₋₄ alkyl group.

As the pyridoneazo-based dye, for example, C.I. Solvent Yellow 162 is well known.

The other dye may be used in any amount as long as they do not exert an adverse influence on the spectral characteristics of the (alkyl)aminoxanthene colorant used in the colored photosensitive resin composition of the present invention. For example, the other dye is used in an amount such that it can maintain the spectral characteristics so as to control a transmittance at a wavelength of 650 nm to 90% or more and to control a transmittance at a wavelength of 535 nm to 1% or less, particularly 0.5% or less. For example, the amount of the pyridoneazo colorant may be selected from a range from about 30 to 70 parts by weight, preferably from about 40 to 60 parts by weight, based on 100 parts by weight of the total amount of the pyridoneazo-based dye and the (alkyl)aminoxanthene colorant, or based on 100 parts by weight of the total amount of the pyridoneazo-based dye, the (alkyl)aminoxanthene colorant and the sulfonic acid-based arylaminoxanthene colorant when the sulfonic acid-based arylaminoxanthene colorant is also used as described below.

The colored photosensitive resin composition of the present invention may be either a positive composition or a negative composition. When the (alkyl)aminoxanthene colorant used in the colored photosensitive resin composition of the present invention is used as the negative composition as it is, it is necessary to pay attention so as to ensure the solubility of the unexposed area since water solubility deteriorates according to the kind of the (alkyl)aminoxanthene colorant, particularly when R¹² of the formula (I) is an ester or an amide. When the solubility of the unexposed area is improved, it is preferable (A) to use a colorant having excellent water solubility (e.g., R¹² is a sulfonic acid group or carboxylic acid group, particularly a sulfonic acid group) as the (alkyl)aminoxanthene colorant, or (B) to use the (alkyl)aminoxanthene colorant in combination with a colorant which is inferior in spectral characteristics but is by far excellent in water solubility as compared with the (alkyl)aminoxanthene colorant.

Examples of the colorant, which is inferior in spectral characteristics but is excellent in water solubility, include a sulfonic acid-based arylaminoxanthene colorant represented by the formula (IV):

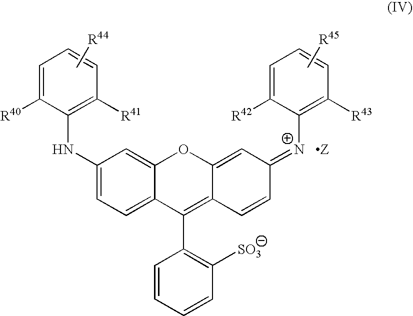

wherein R⁴⁰, R⁴¹, R⁴² and R⁴³ represent independently of each other a hydrogen atom or a C₁₋₃ alkyl group; R⁴⁴ and R⁴⁵ represent independently of each other a sulfonic acid group or an amide represented by the formula (1); and Z represents a hydrogen atom, an alkali metal (e.g., Li, Na, K, etc.), or an amine (e.g., a tertiary amine such as triethylamine, 1-amino-3-phenylbutane, etc.).

The sulfonic acid group for R⁴⁴ and R⁴⁵ may be —SO₃H or a salt thereof (e.g., an alkali metal salt such as an Li salt, a Na salt, a K salt, etc.; or an amine salt such as a triethylamine salt, a 1-amino-3-phenylbutane salt, etc.).

These sulfonic acid-based arylaminoxanthene colorants may be used alone, or two or more of them may be used in combination. In a preferable sulfonic acid-based arylaminoxanthene colorant, at least one of R⁴⁴ and R⁴⁵ is a sulfonic acid group, more preferably both of them are sulfonic acid groups. Specific examples of the sulfonic acid-based arylaminoxanthene colorant include C.T. Acid Red 289.

When the sulfonic acid-based arylaminoxanthene colorant is used in combination, the amount thereof is, for example, from about 0.1 to 80 parts by weight, preferably from about 30 to 50 parts by weight, based on 100 parts by weight of the total amount of the sulfonic acid-based arylaminoxanthene colorant and the (alkyl)aminoxanthene colorant.

Besides the colorant, the colored photosensitive resin composition of the present invention usually contains a photosensitive compound and an alkali-soluble resin in the case of either a positive composition or a negative composition.

The photosensitive compound is appropriately selected according to the positive composition or the negative composition. The photosensitive compound for the positive composition is generally referred to as a photosensitizer and various known photosensitizers may be used. Specific examples of the photosensitizer include an ester of a phenol compound and an o-naphthoquinonediazidesulfonic acid compound (e.g., o-naphthoquinonediazide-5-sulfonic acid, o-naphthoquinonediazide-4-sulfonic acid, etc.).

Examples of the phenol compound include a di-, tri-, tetra- or pentahydroxybenzophenone (e.g., 2,3,4,4′-tetrahydroxybenzophenone, etc.), and compounds represented by the formulae (11) to (21):

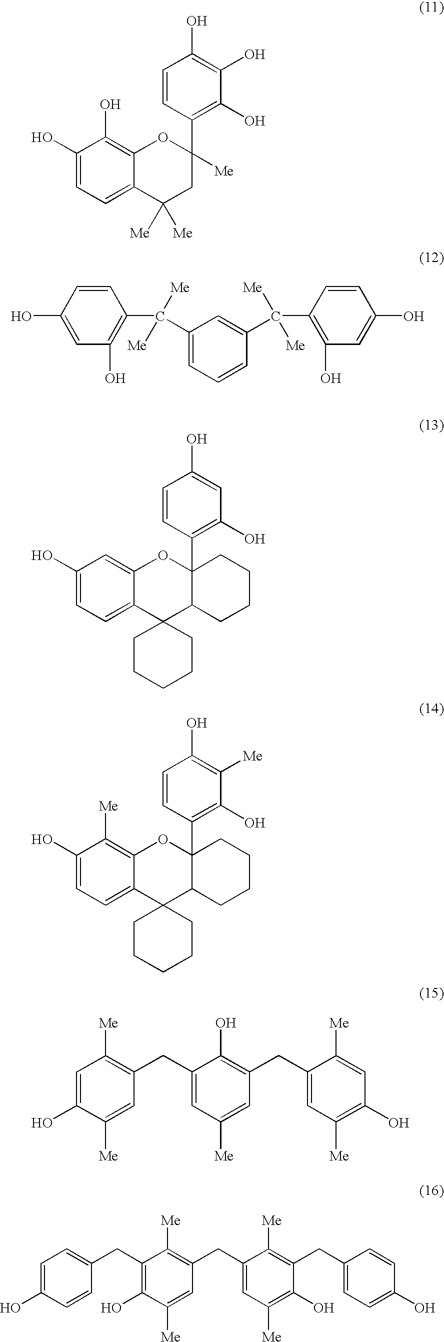

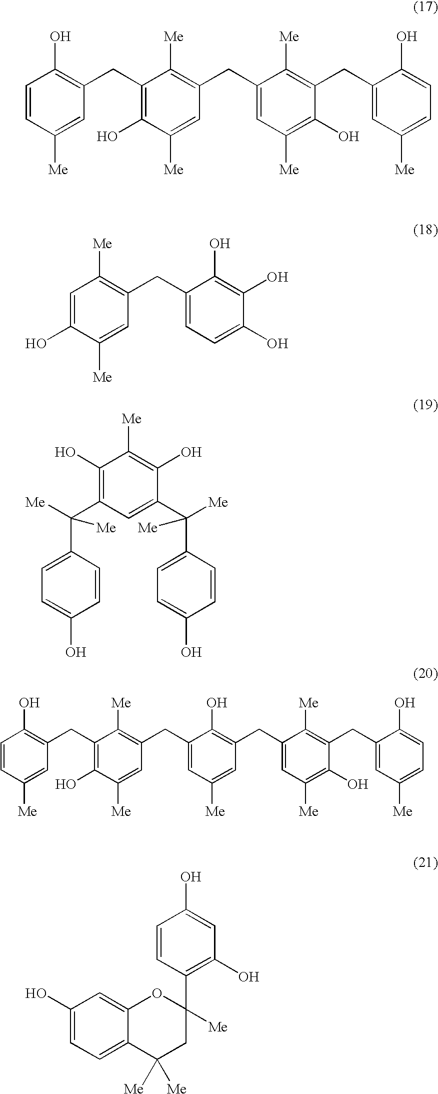

A photo acid generator can be used as the photosensitive compound for the negative composition. The kind of the photo acid generator is not specifically limited and various known photo acid generators may be used. Examples of the photo acid generator include an iodonium salt compound, a sulfonium salt compound, an organic halogen compound (haloalkyl-s-triazine compound, etc.), a sulfonate ester compound, a disulfone compound, a diazomethanesulfonyl compound, an N-sulfonyl oxyimide compound, an oxime compound, etc.). The photo acid generator is preferably an oxime compound.

Specific examples of the oxime compound include cyanides such as α-(4-toluenesulfonyloxyimino)benzyl cyanide, α-(4-toluenesulfonyloxyimino)-4-methoxybenzyl cyanide, α-(camphorsulfonyloxyimino)-4-methoxybenzyl cyanide, α-trifluoromethanesulfonyloxyimino-4-methoxybenzyl cyanide, α-(1-hexanesulfonyloxyimino-4-methoxybenzyl cyanide, α-naphthalenesulfonyloxyimino-4-methoxybenzyl cyanide, α-(4-toluenesulfonyloxyimino)-4-N-diethylanilyl cyanide, α-(4-toluenesulfonyloxyimino)-3,4-dimethoxybenzyl cyanide and α-(4-toluenesulfonyloxyimino)-4-thienyl cyanide; and acetonitriles such as α-[(4-toluenesulfonyloxyimino)-4-methoxyphenyl]acetonitrile, (5-tosyloxyimino-5H-thiophen-2-ylidene)-(2-methylphenyl)acetonitrile, (5-camphorsulfonyloxyimino-5H-thiophen-2-ylidene)-(2-methylphenyl)acetonitrile, (5-n-propyloxyimino-5H-thiophen-2-ylidene)-(2-methylphenyl)acetonitrile and (5-n-octyloxyimino-5-camphorsulfonyloxyimino-5H-thiophen-2-ylidene)-(2-methylphenyl)acetonitrile.

As the alkali-soluble resin, various known alkali-soluble resins used in a photoresist material may be used and, for example, a novolak resin and a polyvinyl resin are used. Specific examples of the novolak resin include a p-cresol novolak resin, an m-cresol novolak resin, a novolak resin of p-cresol and m-cresol and a novolak resin having a repeating structure represented by the formula (31):

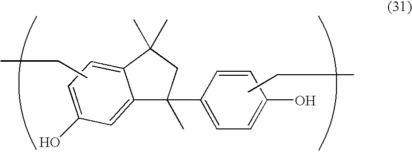

Examples of the polyvinyl resin include a polymer of vinylphenol (p-vinylphenol, also referred to as p-hydroxystyrene, etc.). This polymer may be a homopolymer, or a copolymer (e.g., a copolymer of styrene and p-vinylphenol). If necessary, a hydrogen atom of a hydroxyl group of vinylphenol may be substituted (masked) with an organic group (e.g., a C₁₋₆ alkyl group) When the hydroxyl group is masked with the organic group, the amount of exposing light in the formation of a pattern by a photolithography method can be decreased, and also it become easy to make a pattern shape to be a rectangular shape, which is preferred for a color filter.

The polystyrene-converted weight average molecular weight of the novolak resin is usually from about 3,000 to 20,000, and the polystyrene-converted weight average molecular weight of the polyvinyl resin is usually from about 1,000 to 20,000, preferably from about 2,000 to 6,000.

When the colored photosensitive resin composition contains a photosensitive compound and an alkali-soluble resin, the contents of the colorant, the photosensitive compound and the alkali-soluble resin, based on 100 parts by weight of the total amount of the colorant, the photosensitive compound and the alkali-soluble resin (solid content), are as follows:

Colorant: The amount of the colorant is usually in a range from about 5 to 80 parts by weight, preferably from about 15 to 80 parts by weight, more preferably from about 20 to 70 parts by weight, and particularly from about 30 to 70 parts by weight. With such an amount of the colorant, the color density of the color filter can be sufficiently increased, and also the thickness loss in the developing step upon formation of a pattern can be decreased.

Photosensitive Compound: The amount of the photosensitive compound is usually in a range from about 0.001 to 50 parts by weight, preferably from about 0.01 to 40 parts by weight, more preferably from about 0.1 to 30 parts by weight, and particularly from about 0.1 to 10 parts by weight. With such an amount of the photosensitive compound, the thickness loss in the developing step upon formation of a pattern can be decreased, and also the exposure time in the formation of a pattern by a photolithography method can be shortened.

Alkali-Soluble Resin: The amount of the alkali-soluble resin is in a range from about 1 to 75 parts by weight, preferably from about 5 to 60 parts by weight, more preferably from about 10 to 50 parts by weight. With such an amount of the alkali-soluble resin, preferably the sufficient solubility in a developing solution is achieved, and also the thickness loss is less likely to occur in the developing step and light exposure upon formation of a pattern using a photolithography method decreases.

The colored photosensitive resin composition of the present invention may usually contain a curing agent (a crosslinking agent) and also may optionally contain a solvent and/or a surfactant. A compound having a thermocuring action can be used as the curing agent and, for example, it is possible to use a melamine compound represented by the formula (V):

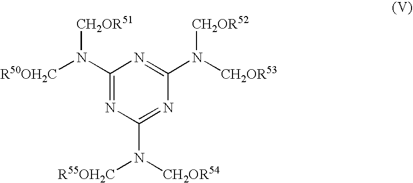

wherein R⁵⁰ to R⁵⁵ represent independently of each other a hydrogen atom, a linear C₁₋₁₀ alkyl group, preferably a linear C₁₋₄ alkyl group, or a C₃₋₁₀ branched chain alkyl group, preferably an isopropyl group, an isobutyl group, a sec-butyl group, a tert-butyl group, etc., provided that at least two substituents among R⁵⁰ to R⁵⁵ are not hydrogen atoms.

Preferable examples of the melamine compounds include hexamethoxymethylmelamine (also referred to as hexamethoxymethylolmelamine) and hexaethoxymethylmelamine.

The content of the curing agent is preferably from 10 to 40% by weight, more preferably from 15 to 30% by weight, based on the solid content of the colored photosensitive resin composition. When the content of the curing agent is preferably within the above range, the amount of exposing light in the case of forming a pattern by a photolithography method can decrease, and a good pattern shape after the development and the sufficient mechanical strength of the pattern after curing the pattern with heating are attained, and also the thickness loss of a pixel pattern does not occur in the developing step and thus the color unevenness of the image is less likely to occur.

A solvent may be adequately selected depending on the solubility of the colorant (dye), the photosensitive compound, the alkali-soluble resin, the curing agent and other components contained in the colored photosensitive resin composition, in particular, the solubility of the colorant. Examples of the solvent include ethylene glycols (e.g., methyl cellosolve, ethyl cellosolve, methyl cellosolve acetate, ethyl cellosolve acetate, diethylene glycol dimethyl ether, ethylene glycol monoisopropyl ether, etc.), propylene glycols (e.g., propylene glycol monomethyl ether, propylene glycol monomethyl ether acetate, etc.), N-methyl pyrrolidone, γ-butyrolactone, dimethyl sulfoxide, N,N-dimethylformamide, ketones (e.g., 4-hydroxy-4-methyl-2-pentanone, cyclohexanone, etc.), carboxylates (e.g., ethyl acetate, n-butyl acetate, ethyl pyruvate, ethyl lactate, butyl lactate, etc.). These solvents may be used alone or in combination.

The content of the solvent is preferably from 65 to 95% by weight, more preferably from 70 to 90% by weight, based on the colored photosensitive resin composition, because within the above range, the uniformity of the coating film can be improved.

Examples of the surfactant include silicone-based surfactant, fluorine-based surfactant, and silicone-based surfactant having a fluorine atom. The silicone-based surfactant includes, for example, a surfactant having a siloxane bond. Specific examples thereof include Toray Silicone DC3PA, Toray Silicone SH7PA, Toray Silicone DC11PA, Toray Silicone SH21PA, Toray Silicone SH28PA, Toray Silicone 29SHPA, Toray Silicone SH30PA, and polyether modified silicone oil SH8400 (manufactured by Toray Silicone Co., Ltd.),; KP321, KP322, KP323, KP324, KP326, KP340, KP341 (manufactured by Shin-Etsu Silicone Co., Ltd.); and TSF400, TSF401, TSF410, TSF4300, TSF4440, TSF4445, TSF-4446, TSF4452, and TSF4460 (manufactured by GE Toshiba Silicones Co., Ltd.). The fluorine-based surfactant includes, for example, a surfactant having a fluorocarbon chain. Specific examples thereof include Fluorad FC430 and Fluorad FC431 (manufactured by Sumitomo 3M, Ltd.); Megafac F142D, Megafac F171, Megafac F172, Megafac F173, Megafac F177, Megafac F183, and Megafac R30 (manufactured by Dainippon Ink and Chemicals, Inc.); Eftop EF301, Eftop EF303, Eftop EF351, and Eftop EF352 (manufactured by Shin-Akita Kasei K.K.); Surflon S381, Surflon S382, Surflon SC101, and Surflon SC105 (manufactured by Asahi Glass Co., Ltd.); E5844 (manufactured by Daikin Finechemical Laboratory), and BM-1000 and BM-1100 (manufactured by BM Chemie). The silicone-based surfactant having a fluorine atom includes, for example, a surfactant having a siloxane bond and a fluorocarbon chain. Specific examples thereof include Megafac R08, Megafac BL20, Megafac F475, Megafac F477, and Megafac F443 (manufactured by Dainippon Ink and Chemicals, Inc.). These surfactants may be used alone or in combination.

When the surfactant is used, the content thereof is preferably from 0.0005 to 0.6% by weight, more preferably from 0.001 to 0.5% by weight, based on the colored photosensitive resin composition, since within the above range, the smoothness of the film can be further improved in the case of coating the colored photosensitive resin composition.

When the colored photosensitive resin composition of the present invention is a negative composition, it may further contain an amine compound. The use of the amine compound can prevent a large change in the amount of exposing light upon photolithography before and after storage of the colored photosensitive resin composition for a long period. The use of the amine compound can decrease the dimensional change of a resist pattern caused by deactivation of a photo acid generator when a substrate is allowed to stand after exposure.

Examples of the former amine compound, which is useful to exert the stabilization effect on the amount of exposing light, include amino alcohols such as 3-amino-1-propanol, 1-amino-2-propanol, 2-amino-1-propanol, 2-amino-2-methyl-1-propanol, 2-amino-2-methyl-1-propanol, 2-amino-2-methyl-1,3-propanediol and 3-methyl-2-amino-1-butanol; and compounds having a diazabicyclo structure, such as 1,4-diazabicyclo[2,2,2]octane, 1,8-diazabicyclo[5,4,0]-7-undecene and 1,5-diazabicyclo[4,3,0]non-5-ene.

Examples of the latter amine compound, which is useful to exert the dimension stabilizing effect, include 4-nitroaniline, ethylenediamine, tetramethylenediamine, hexamethylenediamine, 4,4′-diamino-1,2-diphenylethane, 4,4′-diamino-3,3′-dimethyldiphenylmethane, 4,4′-diamino-3,3′-diethyldiphenylmethane, 4,4′-diamino-3,3′,5,5′-tetraethyl-diphenylmethane, 8-quinolinol, benzimidazole, 2-hydroxybenzimidazole, 2-hydroxyquinazoline, 4-methoxybenzylindene-4′-n-butylaniline, salicylic acid amide, salicylanilide, 1,8-bis(N,N-dimethylamino)naphthalene, 1,2-diazine(pyridazine), piperidine, p-amino-benzoic acid, N-acetylethylenediamine, 2-methyl-6-nitroaniline, 5-amino-2-methylphenol, 4-n-butoxyaniline, 3-ethoxy-n-propylamine, 4-methylcyclohexylamine, 4-tert-butylcyclohexylamine, monopyridines (e.g., imidazole, pyridine, 4-methylpyridine, 4-methylimidazole, 2-dimethylaminopyridine, 2-methylaminopyridine, 1,6-dimethylpyridine, etc.), bipyridines (e.g., bipyridine, 2,2′-dipyridylamine, di-2-pyridyl ketone, 1,2-di(2-pyridyl)ethane, 1,2-di(4-pyridyl)ethane, 1,3-di(4-pyridyl)propane, 1,2-bis(2-pyridyl)ethylene, 1,2-bis(4-pyridyl)ethylene, 1,2-bis(4-pyridyloxy)ethane, 4,4′-dipyridyl sulfide, 4,4′-dipyridyldisulfide, 1,2-bis(4-pyridyl)ethylene, 2,2′-dipicolylamine, 3,3′-dipicolylamine, etc.), and ammonium salts (e.g., tetramethylammonium hydroxide, tetraisopropylammonium hydroxide, tetrabutylammonium hydroxide, tetra-n-hexylammonium hydroxide, tetra-n-octylammonium hydroxide, phenyltrimethylammonium hydroxide, 3-(trifluoromethyl)phenyltrimethylammonium hydroxide, choline, etc.).

The content of the amine compound is usually from about 0.01 to 10% by weight, preferably from about 0.1 to 0.8% by weight, based on the solid content of the colored photosensitive resin composition.

Furthermore, the colored photosensitive resin composition of the present invention may optionally contain various components (e.g., epoxy-based resins, oxetane compounds, ultraviolet absorbers, antioxidants, chelating agents, etc.) as long as the effects of the present invention are not adversely affected.

The colored photosensitive resin composition of the present invention can be prepared by mixing the respective components described above in a solvent. When the colored photosensitive resin composition thus prepared is filtered through a filter having a pore diameter of about 0.1 μm or less, impurity substances having a particle size, which is larger than that of the pore size of the filter, can be removed and the colored photosensitive resin composition can be uniformly coated on a substrate in the case of coating.

Using the colored photosensitive resin composition of the present invention, a color filter array can be formed by a photolithography method which is used to form a color filter array from a conventional colored photosensitive resin composition. In the photolithography method, for example, a coating film made of the colored photosensitive resin composition of the present invention is formed on a substrate and the coating film is exposed and developed to form a pixel. When the formation, exposure and development of the coating film are repeated for each color, a color filter array is formed.

The substrate may be a conventional one, and examples of the substrate include a silicon wafer, a transparent glass plate or a quartz plate, on which an image sensor such as a solid CCD is formed.

To form the coating film on the substrate, for example, the colored photosensitive resin composition of the present invention is coated on the substrate using a coating method such as a spin coating method, a roll coating method, a bar coating method, a die coating method, a dipping method, a casting coating method, a roll coating method, a slit & spin coating method, etc., and then volatile components such as a solvents is removed by heating preferably at a temperature of 70 to 120° C. to form the coating film of the colored photosensitive resin composition of the present invention.

Then, the coating film is exposed. In the exposure process, a mask pattern with a pattern corresponding to the objective pattern is used and the coating film is irradiated with light through the mask pattern. Examples of light ray used in the exposure process include g-ray and i-ray, and the exposure process is conducted using a stepper such as g-ray stepper or i-ray stepper. An exposure dose of light ray in the irradiate area is appropriately selected according to the kind and content of the photosensitive compound, the kind and content of the curing agent, and the polystyrene-converted weight average molecular weight, monomer ratio and content of the alkali-soluble resin. The coating film thus exposed may be heated. The coating film is preferably heated because the curing agent is cured and therefore the mechanical strength of the coating film increases. The heating temperature is preferably from 80 to 150° C.

After the exposure process, the resulting coating film is developed. Similar to the case of using a conventional colored photosensitive resin composition, the coating film is developed by bringing the substrate carrying the coating film into contact with a developing solution. The kind of the developing solution is not particularly limited. For example, an aqueous alkaline solution is used. The desired pixels can be obtained by shaking off the developing solution from the substrate surface and washing the substrate with water. Alternatively, the developing solution is shaken off, followed by rinsing with a rinsing solution and further washing with water. By rinsing, the residue derived from colored photosensitive resin composition remained on the substrate upon development can be removed.

Then, the pixels of the coating film after developing may be irradiated with ultraviolet ray. Thereby, the residual photosensitive compound can be decomposed. Furthermore, the mechanical strength of the pixels can be increased by heating after washing with water. The heating temperature is preferably from 160 to 220° C., since within the above temperature range, the curing agent sufficiently promotes curing, while the dye is not decomposed.

The thickness of the color filter array produced as above is preferably from about 0.4 to 2.0 μm. The longitudinal length and the lateral length of each pixel can be independently set within a range from about 1.0 to 20 μm.

The color filter array of the present invention can be formed on a device such as a solid image pickup device (e.g., CCD, etc.) and a liquid crystal display, and is useful for coloration of such a device.

Typical examples in the case of forming the color filter array of the present invention on a CCD image sensor, and a camera system using the same will now be described in more detail with reference to the accompanying drawings.

CCD Image Sensor:

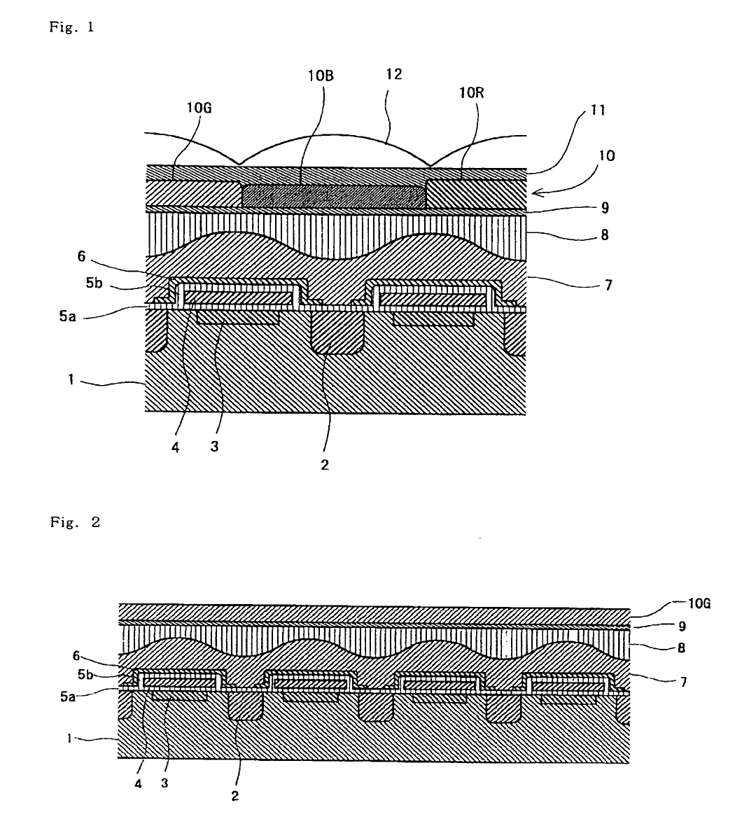

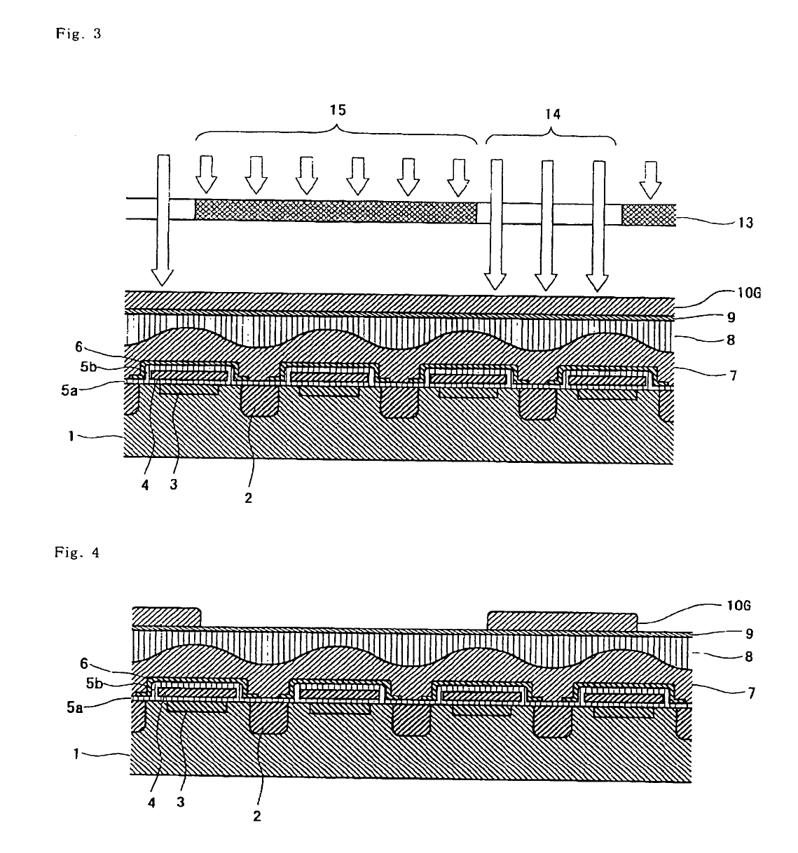

FIG. 1 is a partially enlarged schematic sectional view showing one example of a CCD image sensor on which the color filter array of the present invention is formed, and FIGS. 2 to 7 are partially enlarged schematic sectional views showing procedures for the formation of a color filter on the CCD image sensor shown in FIG. 1.

In the case of a CCD image sensor depicted in the drawings, a photodiode 2 is formed by ion-injecting N-type impurities such as P and As into a portion of the surface of a P-type impurity region in a silicon substrate 1, followed by a heat treatment. Also, a vertical charge transfer section 3 composed of an impurity diffusion layer having an N-type impurity concentration, which is higher than that of the photodiode 2, is formed on the region which exists on the same surface but is different from the portion where the photodiode 2 is formed. The vertical charge transfer section 3 is formed by ion-injecting N-type impurities such as P and As, followed by a heat treatment, and play a role of a vertical Burried Channel layer (CCD) capable of transferring charges generated when the photodiode 2 receives incident light.

In this example, the impurity region of the silicon substrate 1 serves as a P-type impurity layer, while the photodiode 2 and the vertical charge transfer section 3 serve as an N-type impurity layer. Alternatively, the impurity region of the silicon substrate 1 can serve as an N-type impurity layer, while the photodiode 2 and the vertical charge transfer section 3 can serve as a P-type impurity layer.

An insulation film 5a made of, for example, SiO₂ is formed on the silicon substrate 1, the photodiode 2 and the vertical charge transfer section 3, and a vertical charge transfer electrode 4 made of, for example, polysilicon is formed over the vertical charge transfer section 3 through the insulation film 5a. The vertical charge transfer electrode 4 plays a role of a transfer gate capable of transferring charges generated in the photodiode 2 to the vertical charge transfer section 3, and a role of a transfer electrode capable of transferring charges transferred to the vertical charge transfer section 3 to the vertical direction of a chip.

Above and at the side of the vertical charge transfer electrode 4, a light shielding layer 6 is formed through an insulation film 5b made of, for example, SiO₂. The light shielding film 6 is made of tungsten, tungsten silicide, or metal such as Al or Al-silicide, and play a role of preventing incident light from entering into the vertical charge transfer electrode 4 and the vertical charge transfer section 3. Above the photodiode 2 out of the side of the light shielding film 6, a light shielding film 6 is provided with a projecting section, thereby making it possible to prevent incident light from leaking into the vertical charge transfer section 3.

Above the light shielding film 6, for example, a BPSG film 7 is formed with in the form of downward convex against the photodiode 2, and then on the BPSG film 7, a P—SiN film 8 is laminated. Thus, the BPSG film 7 and the P—SiN film 8 are formed such that an interface between them is formed in the form of curving downward above the photodiode 2, and plays a role of an interlayer lens for efficiently bringing incident light to the photodiode 2. For the purpose of flattening irregular portions other than the surface of the P—SiN film 8 or the pixel area, a flattened film layer 9 is formed.

On a flattened film layer 9, a color filter array 10 is formed. The color filter array 10 may be formed in accordance with the above photolithography method. Description is made by way of the CCD image sensor as an example as shown in FIGS. 2 to 7. While the description is made by way of a negative colored photosensitive resin composition in this illustrated example, a positive colored photosensitive resin composition may also be used.

To form the color filter array, firstly, a photosensitive resin composition colored with the first color (in the illustrated example, a green photosensitive resin composition 10G) is applied on a flattened film 9 (FIG. 2) and then projection exposure of a pattern through a photomask 13 is conducted (FIG. 3). This exposure makes the green photosensitive resin composition in the exposed area 14 insoluble in a developing solution. The green photosensitive resin composition in the unexposed area 15 is soluble in the developing solution and then dissolved in the developing solution to form a pattern. Thereafter, the insolubilized green photosensitive resin composition in the remaining exposed area is thermocured to form a desired green pixel pattern 10G (FIG. 4).

Next, the same step is repeated with respect to pixel patterns of other colors (in the illustrated example, a red pixel pattern 10R and a blue pixel pattern 10B) to form pixel patterns of three colors on the same plane of the substrate on which the image sensor is formed (FIG. 5).

On the surface of the color filter array 10 thus formed, a flattened film 11 is formed (FIG. 6) for the purpose of flattening the irregularity. Furthermore, a microlens 12 for efficiently collecting light incident to a photodiode 2 is formed on the top surface of the flattened film 11 (FIG. 1, FIG. 7), thereby forming a CCD image sensor and a camera system using the same.

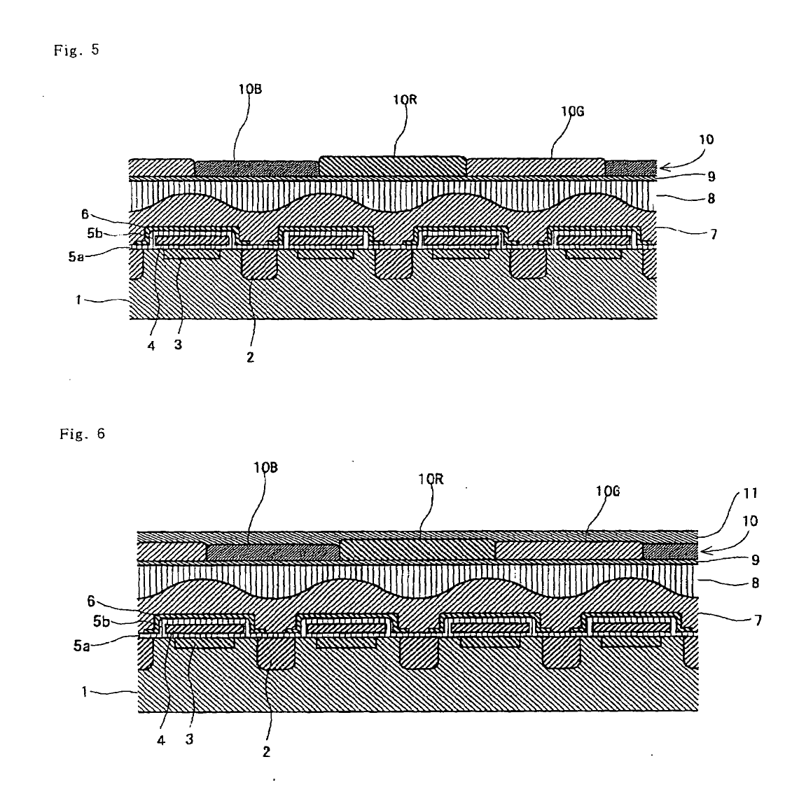

FIG. 8 is a block diagram showing an example of a camera system into which a solid image pickup device (image sensor) is assembled. In this camera system, incident light is illuminated on an image sensor 42 via a lens 41. On the light incident side of the image sensor 42, the above on-chip lens (microlens) 12 and color filter array 10 are formed, and a signal corresponding to each color of incident light is outputted. The signal from the image sensor 42 is signal-processed by the signal processing circuit 43 and then outputted to the camera.

In the camera system of the illustrate example, the image sensor 42 is driven by a device driving circuit 45. The operation of the device driving circuit 45 can be controlled by sending a mode signal such as a static image mode or a moving image mode from a mode setting section 44.

The present invention can be applied to not only a CCD image sensor, but also an amplified solid image pickup device such as a CMOS image sensor, and a camera system and a liquid crystal display using the same.

### EXAMPLES

The present invention is further illustrated by the following examples. It is to be understood that the present invention is not limited to the examples, and various design variations made in accordance with the purports described hereinbefore and hereinafter are also included in the scope of the present invention.

### Synthesis Example 1

36.0 parts by weight of poly(p-hydroxystyrene) [trade name: “MARUKA LYNCUR M” (manufactured by Maruzen Petrochemical Co., Ltd.), weight average molecular weight (catalog value): 4,100, dispersion degree (catalog value): 1.98] and 144 parts by weight of acetone were charged in a reaction vessel and then dissolved while stirring. To the solution, 20.7 parts by weight of anhydrous potassium carbonate and 9.35 parts by weight of ethyl iodide were added, and then reflux was initiated by heating. After reflux was continued for 15 hours, 72 parts by weight of methyl isobutyl ketone was added, and the organic layer was washed with 92.8 parts by weight of a 2 wt. % aqueous oxalic acid solution. Then, 96 parts by weight of ethyl isobutyl ketone was added and the organic layer was washed with 64.7 parts by weight of ion-exchange water. The organic layer after washing was concentrated to 78.3 parts by weight and, after 187.9 parts by weight of propylene glycol monomethyl ether acetate was added, the organic layer was further concentrated to 117.4 parts by weight. The resulting concentrated solution had a solid content of 30.6% by weight. ¹H-NMR measurement revealed that 19.5% of the hydroxyl groups of poly(p-hydroxystyrene) were ethyletherified in the resin after the reaction. This resin is referred to as Resin A.

### Example 1

11 parts by weight of the compound represented by the formula (Ia) described below as an (alkyl)aminoxanthene colorant, 8 parts by weight of C.I. Acid Red 289 as a sulfonic acid-based arylaminoxanthene colorant, 19 parts by weight of C.I. Solvent Orange 56 as a pyrazoloneazo colorant, 18 parts by weight of C.I. Solvent Yellow 162 as a pyridoneazo-based dye, 4 parts by weight of α-[(4-toluenesulfonyloxyimino)-4-methoxyphenyl]acetonitrile as a photosensitive compound, 23 parts by weight in terms of a solid content of the resin A obtained in Synthesis Example 1 as an alkali-soluble resin, 16.4 parts by weight of hexamethoxymethylolmelamine as a curing agent, 392 parts by weight of 4-hydroxy-4-methyl-2-pentanone as a solvent, 98 parts by weight of propylene glycol monomethyl ether as a solvent and 0.15 parts by weight of 2-amino-2-methyl-1-propanol as an amine compound were mixed and then the mixture was filtered through a membrane filter having a pore diameter of 0.2 μm to obtain a red-colored photosensitive resin composition (1).

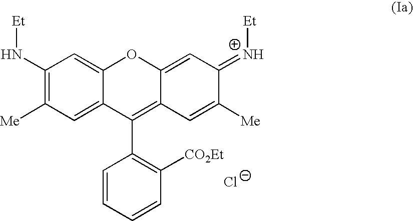

The colored photosensitive resin composition (1) was applied on a quartz wafer by a spin coating method so as to control the thickness of the resulting film to 0.70 μm, and then heated at 100° C. for one minute to remove volatile components, and thus a coating film was formed. The coating film was irradiated with ultraviolet light and then heated at 200° C. for 3 minutes to obtain a red filter.

Patterning by light exposure and development was not conducted since the main object of Example 1 was to evaluate spectral characteristics. However, patterning by light exposure and development can be conducted in the same manner as in the prior art.

### Example 2

A red-colored photosensitive resin composition and a filter were produced in the same manner as in Example 1, except that the combination of colorants was changed to 19 parts by weight of the compound represented by the formula (Ia) as the (alkyl)aminoxanthene colorant, 19 parts by weight of C.I. Solvent Orange 56 as the pyrazoloneazo colorant and 18 parts by weight of C.I. Solvent Yellow 162 as the pyridoneazo-based dye.

### Comparative Example 1

A red-colored photosensitive composition and a filter were produced in the same manner as in Example 1, except that the (alkyl)aminoxanthene colorant of the formula (Ia) was replaced by the arylaminoxanthene colorant represented by the formula (41):

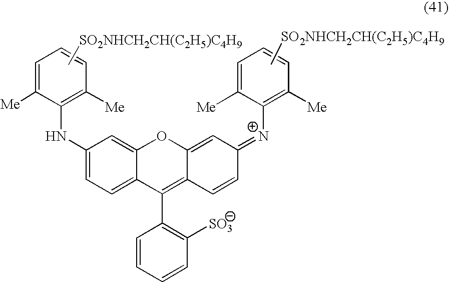

### Comparative Example 2

A red-colored photosensitive composition and a filter were produced in the same manner as in Example 2, except that the (alkyl)aminoxanthene colorant of the formula (Ia) was replaced by the arylaminoxanthene colorant represented by the formula (41).

Spectral Evaluation:

The wavelength-absorbance spectra and the wavelength-transmittance spectra of the filters produced in the Examples and Comparative Examples were measured with a spectrophotometer (“DU-640” manufactured by Beckman Coulter). A film made of the (alkyl)aminoxanthene colorant of the formula (Ia) and a film made of the arylaminoxanthene colorant of the formula (41) were separately formed, and the wavelength-absorbance spectra and the wavelength-transmittance spectra of these films were measured by the same spectrophotometer as above.

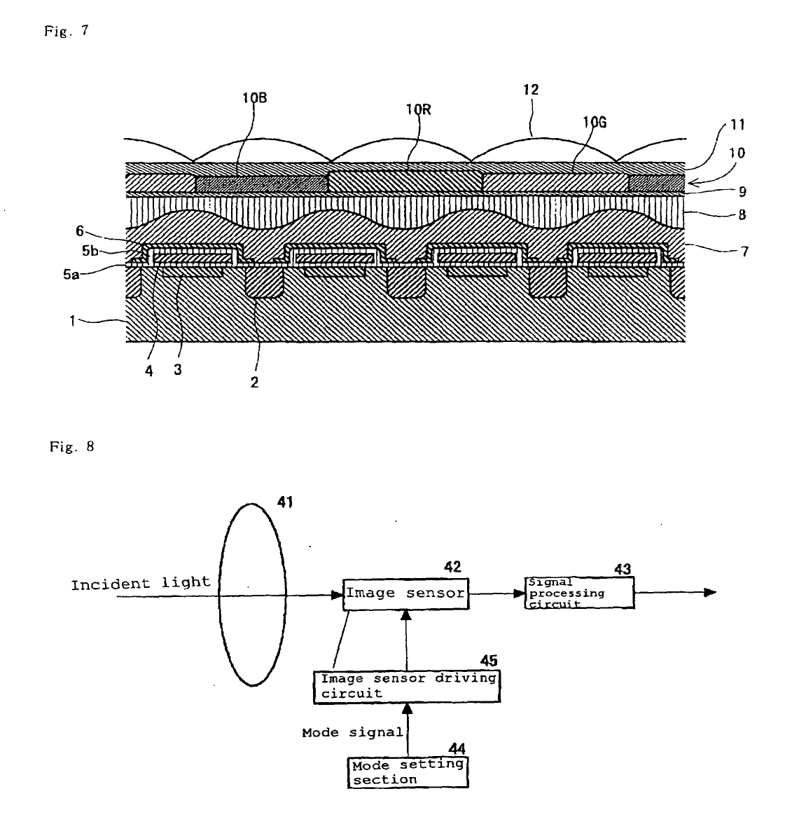

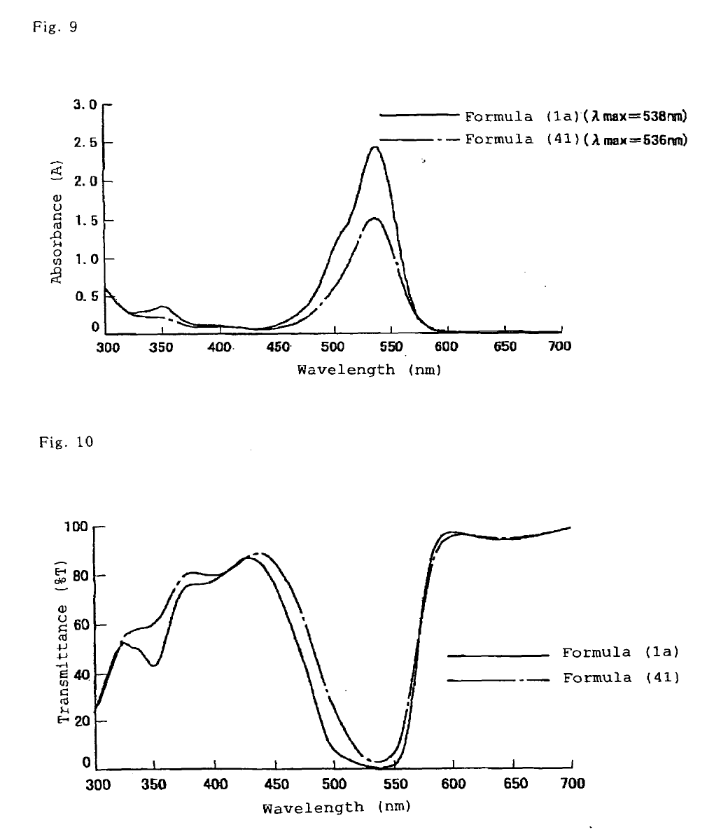

The measurement results of the (alkyl)aminoxanthene colorant of the formula (Ia) and the arylaminoxanthene colorant of the formula (41) are shown in FIGS. 9 and 10. As is apparent from FIG. 9, the (alkyl)aminoxanthene colorant can further enhance the absorbance with substantialy no change in the color tone (i.e. the maximum absorption wavelength (λmax)) as compared with the arylaminoxanthene colorant, and also can further improve the spectral characteristics of the colored photosensitive resin composition and the color filter array. As is apparent from FIG. 10, the (alkyl)aminoxanthene colorant has an ability of controlling the transmittance at a wavelength of 535 nm to 1% or less and also controlling the transmittance at a wavelength of 650 nm to 90% or more.

The measurement results of the filters produced in the Examples and Comparative Examples are shown in Table 1 below.

TABLE 1

Transmittance
(% T)

| | 535 nm | 650 nm |
|---|---|---|
| Example 1 | 0.7% | 91% |
| Example 2 | 0.5% | 90% |
| Comparative Example 1 | 2.1% | 92% |
| Comparative Example 2 | 3.0% | 90% |

As is apparent from Table 1, the filters of the Examples are excellent in spectral characteristics.

1. A colored photosensitive resin composition comprising a photosensitive compound, an alkali-soluble resin, and at least one selected from a compound represented by the formula (I) and a salt thereof: 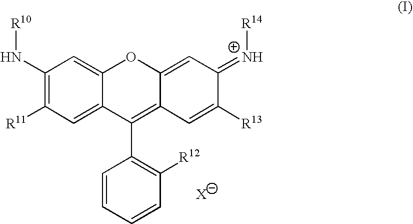
wherein
R¹⁰, R¹¹, R¹³ and R¹⁴ represent independently of each other a hydrogen atom or a C₁₋₈ alkyl group;
R¹² represents a sulfonic acid group, a carboxylic acid group, an ester thereof, or an amide represented by the formula (1):
—SO₂NHR⁵ (1)
in which R¹⁵ represents a C₂₋₂₀ alkyl group; a C₂₋₁₂ alkyl group substituted with a cyclohexyl group; a cyclohexyl group substituted with a C₁₋₄ alkyl group; a C₂₋₁₂ alkyl group substituted with a C₂₋₁₂ alkoxyl group; an alkylcarbonyloxyalkyl group represented by the formula (1-1); an alkoxycarbonyl alkyl group represented by the formula (1-2); a phenyl group which may be substituted with a C₁₋₂₀ alkyl group; or a C₁₋₂₀ alkyl group which may be substituted with a phenyl group:
—R¹⁷O—CO—R¹⁶ (1-1)
—R¹⁹—CO—R¹⁸ (1-2)
in which formulae (1-1) and (1-2), R¹⁶ and R¹⁸ represent independently of each other a C₂₋₁₂ alkyl group, and R¹⁷ and R¹⁹ represent independently of each other a C₂₋₁₂ alkylene group; and
X⁻ represents BF₄⁻, PF₆⁻, Y⁻ or YO₄⁻ (in which Y represents a halogen atom), or a dye having a sulfonic acid group.

2. The colored photosensitive resin composition according to claim 1, wherein the photosensitive compound is an oxime compound.

3. The colored photosensitive resin composition according to claim 1, further comprising a colorant having a maximum absorption at a wavelength of 400 to 500 nm.

4. The colored photosensitive resin composition according to claim 1, wherein the content of the colorant is from 5 to 80 parts by weight based on 100 parts by weight of the total of the colorant, the photosensitive compound and the alkali-soluble resin.

5. The colored photosensitive resin composition according to claim 1, wherein the content of the photosensitive compound is from 0.001 to 50 parts by weight based on 100 parts by weight of the total of the colorant, the photosensitive compound and the alkali-soluble resin.

6. The colored photosensitive resin composition according to claim 1, wherein the content of the alkali-soluble resin is 1 to 75 parts by weight based on 100 parts by weight of the total of the colorant, the photosensitive compound and the alkali-soluble resin.

7. The colored photosensitive resin composition according to claim 1, further comprising a curing agent.

8. A color filter array formed from the colored photosensitive resin composition according to claim 1.

9. A solid image pickup device comprising the color filter array according to claim 8.

10. A camera system comprising the color filter array according to claim 8.

11. The colored photosensitive resin composition according to claim 2, further comprising a colorant having a maximum absorption at a wavelength of 400 to 500 nm.
